(19) United States
(12) Patent Application Publication
(10) Pub. No.: US 2020/0077472 A1
(43) Pub. Date: Mar. 5, 2020

(54) COOKING DEVICE AND METHOD FOR ASSEMBLING A COOKING DEVICE

(71) Applicant: BSH Hausgeräte GmbH, Munich (DE)

(72) Inventors: Jose Maria De la Cuerda Ortin, Zaragoza (ES); Juan Jose Galindo Perez, Zaragoza (ES); Pablo Jesus Hernandez Blasco, Zaragoza (ES); Izaskun Jaca Equiza, Zaragoza (ES); Ignacio Lope Moratilla, Zaragoza (ES); Damaso Martin Gomez, Zaragoza (ES); Maria Elena Moya Albertin, Zaragoza (ES); Carlos Obon Abadia, Zaragoza (ES); Jose Joaquin Paricio Azcona, Zaragoza (ES); Alvaro Rigual Iturria, Zaragoza (ES); Pablo Ruiz Arnal, Zaragoza (ES)

(21) Appl. No.: 16/467,507

(22) PCT Filed: Dec. 12, 2017
(86) PCT No.: PCT/IB2017/057826

§ 371 Date: Jun. 7, 2019

(30) Foreign Application Priority Data
Dec. 23, 2016 (ES) P201631671

(51) Int. Cl. H05B 6/12; H05B 6/36

(52) U.S. Cl. CPC H05B 6/129; H05B 6/362; H05B 6/36

(57) ABSTRACT

A cooking device includes a heating coil having at least two windings. A fixing device is provided to fix the heating coil at least partially mechanically in an assembled state. The fixing device includes a support unit and a retaining unit, which in the assembled state fixes each of the at least two windings separately on the support unit.

The invention relates to a cooking device according to the preamble of claim 1 and a method for assembling a cooking device according to claim 12.

Cooking appliances with a number of heating coils, which are mechanically fixed in an assembled state by means of a fixing device, are known from the prior art.

The object of the invention is in particular to provide a generic cooking device with improved properties as regards stability. The object is achieved by the characterizing features of claim 1 and by the features of the claim 12, while advantageous embodiments and developments of the invention can be derived from the subclaims.

The invention is based on a cooking device, in particular an oven device and advantageously an induction oven device, with at least one heating coil, which has at least two, advantageously at least four and particularly preferably at least eight, windings, and with at least one fixing device, which mechanically fixes the heating coil in an assembled state at least partially, in particular at least for the most part and particularly preferably completely.

It is recommended that the fixing device comprises a support unit and a retaining unit, in particular embodied separately from the support unit, which in the assembled state fixes each of the windings separately to the support unit, in particular in such a way that a mechanical movement of the windings relative to each other and/or relative to the support unit is at least essentially prevented.

In this connection a “cooking device” should in particular be taken to mean at least one part, in particular a subassembly, of a cooking appliance, in particular of a cooktop, of a grill appliance, a microwave oven and/or preferably of an oven. The cooking appliance is here advantageously embodied as an induction cooling appliance, in particular as an induction cooktop, as an induction grill, as an induction microwave oven and/or particularly preferably as an induction oven. A “heating coil” should in particular be taken to mean an advantageously inductive element, in particular a heating element, which in particular consists of at least one, preferably exactly one heating cable, in particular a heating conductor, and in particular has a multiplicity of windings, in particular in a number of planes and/or advantageously in one plane. Viewed from above, the heating coil can in particular have a circular, an oval and/or preferably a rectangular form and/or contour. The heating coil could here for example be embodied as a resistance heating element. Advantageously, however, the heating coil is embodied as an induction heating element. In this connection, a “winding” of a heating coil should be taken to mean in particular exactly one circulation of the heating coil, in particular of the heating cable of the heating coil through 360°, in particular relative to a central reference point, in particular a geometric center of the heating coil and in particular when viewed perpendicular to a main extension plane of the heating coil. The word “provided” should in particular be taken to mean specially designed and/or equipped. That an object is provided for a particular function should in particular be taken to mean that the object fulfills and/or performs this particular function in at least one usage and/or operating status.

In this connection a “support unit” should in particular be taken to mean an, advantageously at least partially shape-retaining, unit, which is provided to bear an object arranged on and/or over the support unit, in particular the heating coil, and here in particular to take up, at least partially the weight of the object, in particular of the heating coil. To this end, the support unit can comprise in particular at least one support element or a multiplicity of support elements. The at least one support element here preferably consists at least partially and preferably at least for the most part of a solid material, in particular plastic and/or preferably electrically insulating material, preferably mica. Particularly preferably, at least two of the support elements are further arranged in a common plane. In this connection, a “retaining unit” should in particular be taken to mean a unit which is provided to fix the object arranged in particular on and/or over the support unit, in particular the heating coil and preferably each winding of the heating coil, separately on the support unit, preferably in a friction-locked and/or form-fitted manner, so that in particular a mechanical movement of the object, in particular of the heating coil and preferably each winding of the heating coil, is at least essentially prevented. To this end, the retaining unit preferably comprises at least two, preferably at least four and particularly preferably at least eight retaining elements in particular embodied separately from each other, wherein at least one of the retaining elements is preferably assigned to each of the windings. The indication that the retaining unit “in the assembled state fixes each of the windings separately to the support unit”, should in particular be taken to mean that the retaining unit connects each of the windings separately to the support unit for fixing of the heating coil. The retaining unit here advantageously encompasses each of the windings at least for the most part. Particularly preferably, at least one retaining element of the retaining unit enables, in each case individually, an advantageously friction-locked and/or form-fitted fixing of an area of an individual winding of the heating coil to at least one support element of the support unit, in particular spatially separated from at least one further retaining element of the retaining unit. The expression “at least essentially prevents” should further in particular be taken to mean that a maximum freedom of movement of the windings relative to each other and/or relative to the support unit amounts to at most 5 mm, advantageously at most 1 mm, preferably at most 2 mm and particularly preferably at most 0.5 mm. Further, the expression “at least for the most part” should be taken to mean in particular at least 55%, advantageously at least 65%, preferably at least 75%, particularly preferably at least 85% and particularly advantageously at least 95%. An advantageous stability can in particular be achieved by means of this embodiment of the cooking device. In particular, a stable spatial fixing of the heating coil with different geometries can be achieved, including in the case of high temperatures exceeding 500° C., without functional limitation. In addition, an advantageously simple assembly and/or manufacture can be achieved, by means of which in particular material and/or costs can be saved.

In one preferred embodiment it is recommended that the retaining unit consists at least partially, preferably at least for the most part and particularly preferably completely, of a material with a thermal expansion coefficient which is at least essentially identical to a thermal expansion coefficient of the heating coil. Here, at least one retaining element of the retaining unit preferably consists of a metal, in particular an alloy and/or advantageously steel and/or copper. In particular an at least partially uniform thermal expansion of the heating coil and/or of the retaining unit can hereby be achieved and in particular a stable fixing of the heating coil attained.

It is additionally recommended that the retaining unit comprises a multiplicity of advantageously disconnected and/or separate, retaining elements, in particular the aforementioned retaining elements, wherein at least two of the retaining elements are assigned to at least one of the windings. In this case, the retaining elements are advantageously arranged in the circumferential direction of the winding. Particularly preferably, at least two, preferably at least three and particularly preferably at least four retaining elements are assigned to at least one of the windings and advantageously to each of the windings of the heating coil. A particularly stable fixing of the windings on the support unit can hereby advantageously be achieved.

In one particularly preferred embodiment of the invention it is recommended that the retaining unit is embodied at least partially in one piece with the heating coil. In this connection, indicating that an object is “embodied at least partially in one piece” with a further object, should in particular be taken to mean that the objects have at least one common component and/or at least one component of the object and/or the object is connected and/or embodied in one piece with at least one component of the further object and/or the further object. Preferably, however, all components of the object are embodied in one piece with at least one component of the further object. In this connection, “in one piece” should in particular be taken to mean at least connected in a bonded manner and/or embodied with each other. The bonding can for example be created by means of an adhesive process, a spray process, a welding process, a soldering process and/or another process. In one piece should advantageously be taken to mean formed from one piece and/or in one piece. This one piece is preferably manufactured from a single blank, a shape and/or a casting. In particular, at least one retaining element of the retaining unit is embodied in one piece with the heating coil. Material and/or production costs can thereby be advantageously saved and in particular assembly effort reduced.

An advantageously simple and/or space-saving fixing of the windings can in particular be achieved if the retaining unit has at least one retaining element, which is embodied as a retaining clasp, retaining hook, retaining clip and/or retaining bolt. In particular the retaining unit can have at least one retaining element, which has an extension in the direction of a winding loop of the heating coil, which amounts to at most 40%, preferably at most 30% and particularly preferably at most 20% of a material extension, in particular a material thickness, of the windings, in particular viewed perpendicular to a main extension plane of the heating coil. The expression “main extension plane” of an object should in particular be taken to mean a plane which is parallel to a largest lateral face of a smallest, in particular notional, cuboid, which only just completely encloses the object, and which in particular runs through a center, in particular a geometric center, of the cuboid.

In one particularly preferred embodiment of the invention it is recommended that the support unit is embodied at least partially, preferably at least for the most part and particularly preferably completely, to be electrically insulating. In particular, the support unit here consists at least partially of an electrically insulating material, in particular of mica and/or plastic. Increased operating safety can thereby in particular be guaranteed and operating costs can advantageously be reduced.

It is further recommended that the support unit comprises a multiplicity of at least essentially strip-like support elements. An “at least essentially strip-like object” should in particular be taken to mean an object which has a form and/or contour which diverges from a strip-like reference object by a proportion of its area of at most 15%, advantageously at most 10% and particularly preferably at most 5%. A fixing of the windings in all spatial directions can thereby be advantageously increased.

It is further recommended that in an assembled state the support elements are arranged at least essentially perpendicular to each other. That the support elements “are arranged essentially perpendicular to each other” should here in particular be taken to mean that the longitudinal axes of two adjacent strip-type support elements along the direction of the windings of the heating coil enclose an angle which in particular diverges by less than 12°, advantageously less than 7° and particularly advantageously less than 2° form 90°. An advantageously simple and in particular stable orientation can thereby be achieved.

It is additionally recommended that the support unit has at least one retaining recess for accommodating the retaining unit. The support unit preferably has a multiplicity of retaining recesses. The number of retaining recesses is particularly preferably matched to the number of retaining elements. Advantageously, one of the retaining recesses is here assigned to each of the retaining elements. The retaining recesses are here preferably embodied as an opening corresponding to the retaining element. Assembly can thereby in particular be facilitated and/or a stable fixing achieved.

It is further recommended that the cooking device comprises a positioning unit, which is provided for positioning of the retaining unit and/or of the support unit relative to the heating coil. A “positioning unit” should in particular be taken to mean in particular a unit with at least one positioning element, which is provided in particular to orient the retaining unit, the support unit and/or the heating coil relative to each other. The positioning unit is preferably embodied in one piece with the heating coil. The positioning element could for example be embodied in the form of a hook. However the positioning element is preferably embodied as a notch, preferably in the form of an advantageously bilateral recess of the heating coil, in particular of the heating cable of the heating coil and/or a recess in the center of the heating coil. The positioning unit preferably has a multiplicity of positioning elements. Particularly preferably, the number of positioning elements is matched to the number of retaining elements. One of the positioning elements is here advantageously assigned to each of the retaining elements. An advantageously simple orientation can thereby in particular be achieved.

In addition, a method for assembly of a cooking device is recommended, which has at least one heating coil with at least two windings and which has at least one fixing device, which mechanically fixes the heating coil in an assembled state at least partially, in particular at least for the most part and particularly preferably completely, wherein each of the windings is fixed separately to a support unit of the fixing device by means of a retaining unit of the fixing device. An advantageous stability can thereby in particular be achieved. In particular, a stable spatial fixing of the heating coil with different geometries can be achieved, including in the case of high temperatures exceeding 500° C., without functional limitation. In addition, an advantageously simple assembly and/or production can thereby be achieved, by means of which in particular material and/or costs can be saved.

Further advantages emerge from the following description of the drawing. The drawing shows exemplary embodiments of the invention. The drawing, the description and the claims contain numerous features in combination. The person skilled in the art will expediently also consider the features individually, and put them together into sensible further combinations.

Wherein:

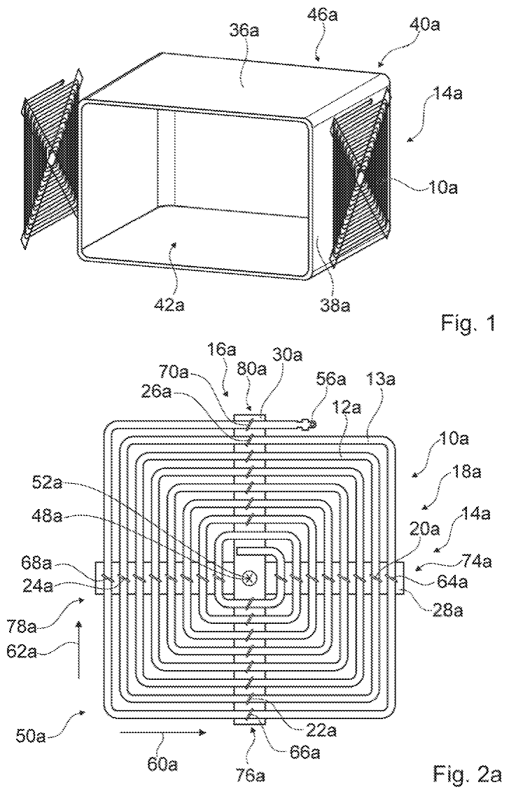

FIG. 1 shows a cooking appliance embodied, by way of example, as an induction oven with a cooking device, in a schematic representation,

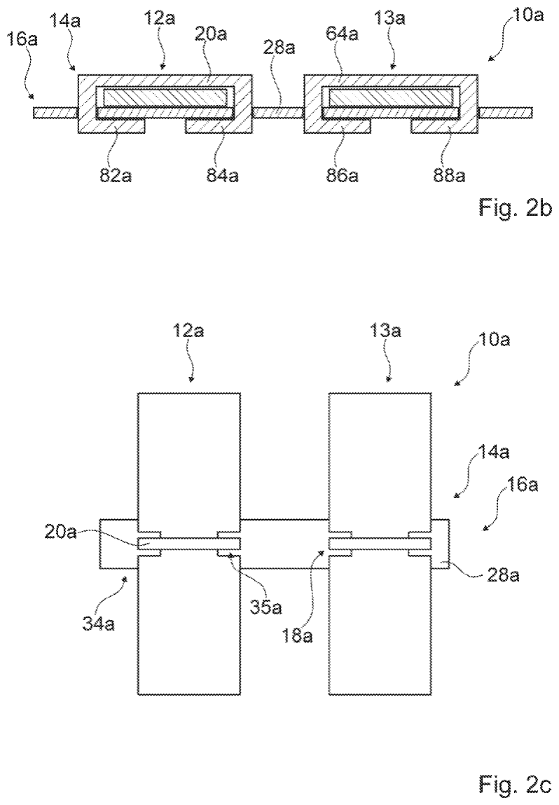

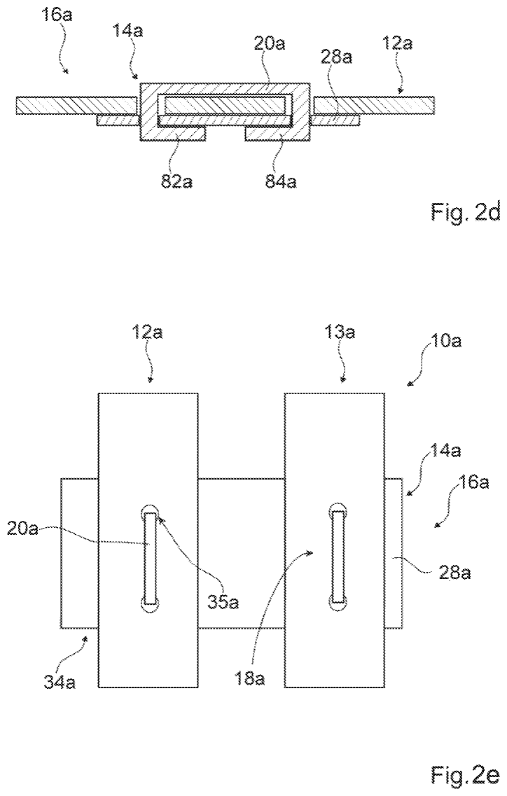

FIG. 2a shows a heating coil and a fixing device of the cooking device in an assembled state,

FIG. 2b shows a first detail view of the heating coil and the fixing device, FIG. 2c a second detail view of the heating coil and the fixing device, FIG. 2b a third detail view of the heating coil and the fixing device, FIG. 2c a fourth detail view of the heating coil and the fixing device,

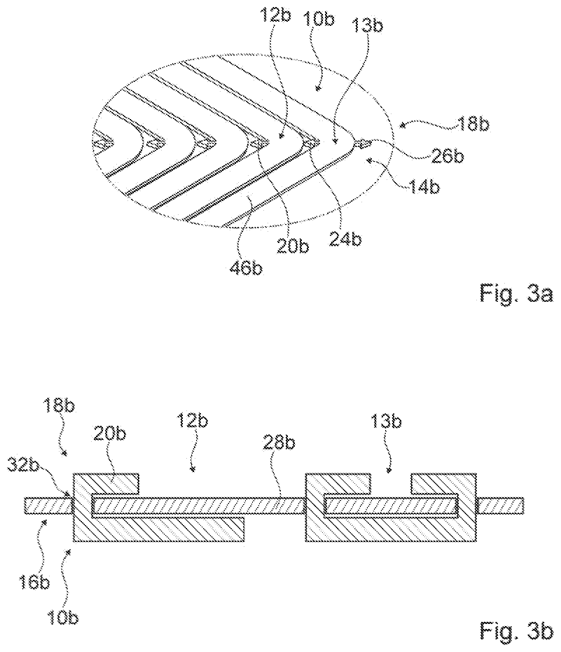

FIG. 3a shows a further exemplary embodiment of a further cooking device with a heating coil and a fixing device in a first detail view,

FIG. 3b shows a heating coil and the fixing device from FIG. 3a in a second detail view,

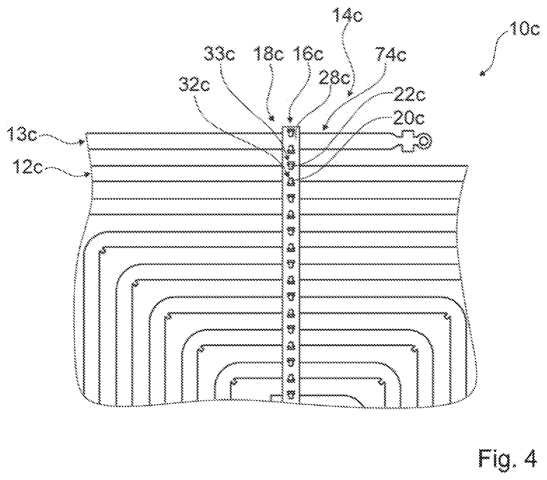

FIG. 4 shows a further exemplary embodiment of a further cooking device with a heating coil and a fixing device in a detail view,

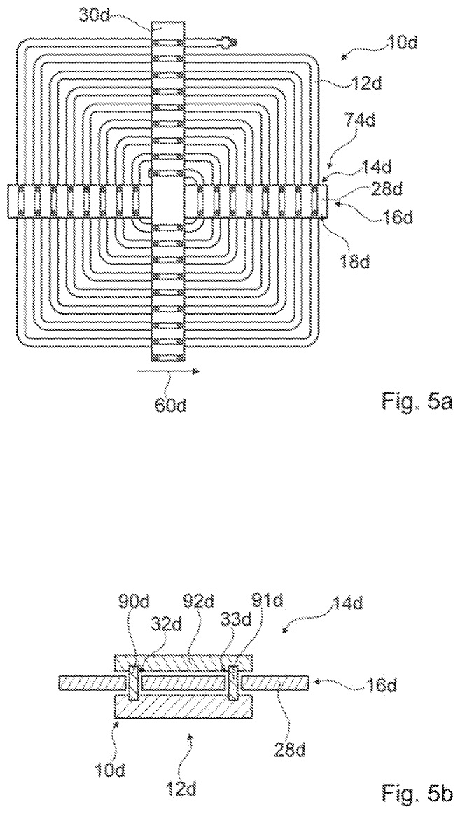

FIG. 5a shows a further exemplary embodiment of a further cooking device viewed from above

FIG. 5b shows the heating coil and the fixing device from FIG. 5a with a heating coil and a fixing device in a first detail view and

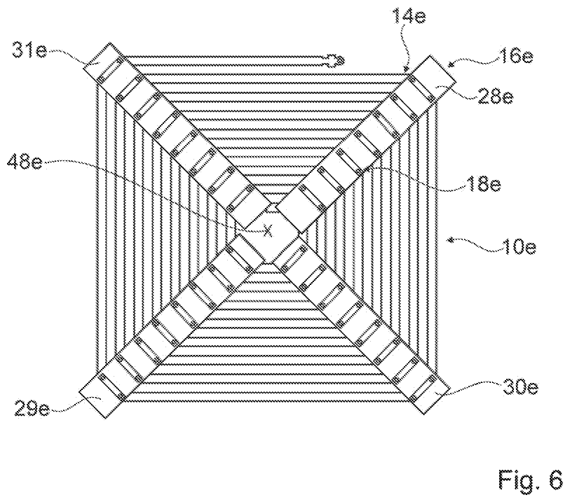

FIG. 6 shows a further exemplary embodiment of a further cooking device with a heating coil and a fixing device viewed from above.

FIG. 1 shows a cooking appliance 40a in a perspective view. In the present case the cooking appliance 40a is embodied, by way of example, as an oven, in the present case in particular as induction oven. Alternatively, a cooking appliance could also be embodied as an induction grill appliance, as a microwave oven or as an induction cooktop.

The cooking appliance 40a comprises a cooking device. The cooking device comprises a cooking appliance housing 46a. The cooking appliance housing 46a defines a cooking compartment 42a. To this end, the cooking appliance housing 46a comprises an external housing (not shown) and a muffle 36a with at least one muffle wall 38a arranged within the external housing, delimiting the cooking compartment 42a. In addition, the muffle 36a comprises further muffle walls, which for the sake of clarity are not provided with reference characters. In addition, the cooking device comprises an appliance closure element (not shown). The appliance closure element is in the present case embodied as an appliance flap. The appliance closure element is provided to close the cooking compartment 42a. Alternatively, however, an appliance closure element could also be embodied as an appliance door.

The cooking device further comprises a heating coil 10a. The heating coil 10a is arranged in the cooking appliance housing 46a. The heating coil 10a is arranged flat on the muffle wall 38a. In the present case the heating coil 10a is embodied as an induction heating element. The heating coil 10a is provided to effect heating of the muffle wall 38a by means of an alternating electromagnetic field. The heating coil 10a is further provided to heat foodstuffs to be cooked located in the cooking compartment 42a.

In addition, the cooking device comprises a fixing device 14a. The fixing device 14a is arranged in the cooking appliance housing 46a. The fixing device 14a is arranged on the heating coil 10a. The fixing device 14a is provided to fix the heating coil 10a mechanically in an assembled state. In addition, the cooking device comprises further heating coils and further fixing devices arranged on the further muffle walls, which are at least essentially structurally identical to the heating coil 10a and the fixing device 14a and to which, for the sake of clarity, no reference character has been assigned.

FIGS. 2a, 2b and 2c show the heating coil 10a and the fixing device 14a in a number of detailed representations. The description that follows can here also be transferred to the further heating coils and fixing devices, in particular as a result of the at least essentially structurally identical embodiment.

The heating coil 10a is embodied from a ribbon-like heating conductor, which in particular in the present case has a rectangular cross-section. The heating coil 10a is embodied from a single heating conductor. The heating coil 10a is embodied in copper. The heating coil 10a comprises a multiplicity of windings 12a, 13a. In the present case the heating coil 10a comprises a total of eight windings 12a, 13a, wherein in FIGS. 2a to 2c, for the sake of clarity, only two of the windings 12a, 13a are provided with a reference character and/or are represented. The windings 12a, 13a of the heating coil 10a form a flat coil plane 50a. All windings 12a, 13a of the heating coil 10a are here arranged in the coil plane 50a. Additionally, the heating coil 10a has a coil center point 48a arranged in the coil plane 50a, around which the windings 12a, 13a extend. In addition, the heating coil 10a has a coil axis 52a which is oriented perpendicular to the coil plane 50a and in particular runs through the coil center point 48a.

When viewed in the direction of the coil axis 52a, the heating coil 10a has a rectangular form and/or contour. Alternatively, however, a heating coil could also have a circular and/or oval form and/or contour. In principle it is further also conceivable to embody a heating coil from a multiplicity of heating conductors and/or one stranded conductor. A heating coil could also be embodied at least partially from a material other than copper, such as for example silver and/or gold. In addition, a heating coil could comprise a number of windings other than eight.

The heating coil 10a additionally has a connection element 56a at one end. The connection element 56a is embodied as an annular aperture. The connection element 56a is embodied as a lug. The connection element 56a is provided for connection of the heating coil 10a to a source of current. Alternatively, a connection element can be embodied as copper wire.

The fixing device 14a comprises a support unit 16a. The support unit 16a is at least essentially arranged in a plane. The support unit 16a is arranged in a plane which is arranged parallel to the coil plane 50a. The support unit 16a is provided to take up, at least partially, the weight of the heating coil 10a. The support unit 16a is further provided to orient the windings 12a,13a of the heating coil 10a relative to each other.

To this end the support unit 16a comprises a number of support elements 28a, 30a, although it can be a single element that comprises all or most of the surface of the heating coil 10. In the present case the support unit 16a comprises two support elements 28a, 30a, in particular a first support element 28a and a second support element 30a. The support elements 28a, 30a are in the present case at least essentially structurally identical. Alternatively, a support unit can comprise only a single support element or at least three and/or at least four support elements. In addition, a first and a second support element could be embodied differently from each other.

The first support element 28a is embodied in longitudinal form, and defines a first longitudinal extension direction 60a. The first support element 28a is embodied as a rigid body. The first support element 28a is embodied in elongated form. The first support element 28a is embodied in a strip-like manner. The first support element 28a, in particular a wing of the first support element 28a, is oriented parallel to the heating coil 10a, in particular the coil plane 50a. The first support element 28a extends from a first longitudinal side of the heating coil 10a to a second longitudinal side of the heating coil 10a lying opposite the first longitudinal side. The first longitudinal extension direction 60a of the first support element 28a here runs through the coil axis 52a. The first support element 28a is further embodied from an electrically insulating material. In the present case, the first support element 28a is embodied from a plastic material, for example a sheet silicate, in particular mica.

The second support element 30a is embodied in longitudinal form, and defines a second longitudinal extension direction 62a. The second longitudinal extension direction 62a is perpendicular to the first longitudinal extension direction 60a. Accordingly, the second support element 30a is arranged perpendicular to the first support element 28a. The second support element 30a is embodied as a rigid body. The second support element 30a is embodied in elongated form. The second support element 30a embodied in a strip-like manner. The second support element 30a, in particular a wing of the second support element 30a, is oriented parallel to the heating coil 10a, in particular the coil plane 50a. The second support element 30a extends from a third longitudinal side of the heating coil 10a to a fourth longitudinal side of the heating coil 10a lying opposite the third longitudinal side. The second longitudinal extension direction 62a of the second support element 30a here runs through the coil axis 52a. The second support element 30a is further embodied from an electrically insulating material. In the present case, the second support element 30a is embodied from a plastic material, for example from a sheet silicate, in particular mica. Alternatively, it is conceivable to embody a first and/or a second support element from a metal. In addition, a first and a second support element could have a parallel orientation. Additionally, at least one support element could be embodied from a material other than sheet silicate, such as, for example, a plastic.

The fixing device 14a further comprises a retaining unit 18a. The retaining unit 18a is embodied as a mechanical structural unit. The retaining unit 18a is embodied from a material with a thermal expansion coefficient which is essentially identical to a thermal expansion coefficient of the heating coil 10a. The retaining unit 18a is embodied from a metallic material. The retaining unit 18a consists in the present case at least for the most part of steel, in particular copper-clad steel. Alternatively, it is also possible to embody a retaining unit in any desired material other than copper, such as for example a plastic, and/or as an adhesive retaining unit. The retaining unit 18a is arranged on the heating coil 10a. The retaining unit 18a is further arranged on the support unit 16a. The retaining unit 18a is provided to fix each of the windings 12a, 13a of the heating coil 10a separately on the support unit 16a in an assembled state.

To this end, the retaining unit 18a comprises a multiplicity of retaining elements 20a, 22a, 24a, 26a, 64a, 66a, 68a, 70a, wherein in FIG. 2a, for the sake of clarity, only eight of the retaining elements 20a, 22a, 24a, 26a, 64a, 66a, 68a, 70a have been provided with reference characters. The number of retaining elements 20a, 22a, 24a, 26a, 64a, 66a, 68a, 70a is here matched to the number of windings 12a, 13a. In the present case, exactly four retaining elements 20a, 22a, 24a, 26a, 64a, 66a, 68a, 70a are assigned to each of the windings 12a, 13a of the heating coil 10a. The retaining elements 20a, 22a, 24a, 26a, 64a, 66a, 68a, 70a are here in each case embodied identically to each other. In the present case, the retaining elements 20a, 22a, 24a, 26a, 64a, 66a, 68a, 70a are in each case embodied as clips. Alternatively, however, it is also conceivable, to assign one and/or two retaining elements to each winding of a heating coil. It is also conceivable to assign one retaining element to two and/or three windings in each case. Furthermore, it is possible to embody retaining elements differently from each other and/or to combine differently embodied retaining elements with each other.

In the present case, four retaining elements 20a, 22a, 24a, 26a, in particular a first retaining element 20a, a second retaining element 22a, a third retaining element 24a and a fourth retaining element 26a, are assigned to a winding 12a of the heating coil 10a. The retaining elements 20a, 22a, 24a, 26a here fix the winding 12a onto the support elements 28a, 30a. The retaining elements 20a, 22a, 24a, 26a, are evenly distributed along a loop of the winding 12a. The retaining elements 20a, 22a, 24a, 26a are spaced by rotation through 90° relative to the coil center point 48a. The first retaining element 20a is arranged in the center of a first straight coil section 74a of the heating coil 10a. The second retaining element 22a is arranged in the center of a second straight coil section 76a of the heating coil 10a. The third retaining element 24a is arranged in the center of a third straight coil section 78a of the heating coil 10a. The fourth retaining element 26a is arranged in the center of a fourth straight coil section 80a of the heating coil 10a.

Four further retaining elements 64a, 66a, 68a, 70a, in particular a fifth retaining element 64a, a sixth retaining element 66a, a seventh retaining element 68a and an eighth retaining element 70a, are assigned to the further winding 13a of the heating coil 10a. The further retaining elements 64a, 66a, 68a, 70a here fix the further winding 13a onto the support elements 28a, 30a. The further retaining elements 64a, 66a, 68a, 70a are evenly distributed along a loop of the further winding 13a. The further retaining elements 64a, 66a, 68a, 70a are spaced by rotation through 90° relative to the coil center point 48a. The fifth retaining element 64a is arranged in the center of the first straight coil section 74a of the heating coil 10a. The sixth retaining element 66a is arranged in the center of the second straight coil section 76a of the heating coil 10a. The seventh retaining element 68a is arranged in the center of the third straight coil section 78a of the heating coil 10a. The eighth retaining element 70a is arranged in the center of the fourth straight coil section 80a of the heating coil 10a. In the case of a thermal expansion of the heating coil 10a, a movement of the winding 12a relative to the further winding 13a is prevented by means of the retaining elements 20a, 22a, 24a, 26a, 64a, 66a, 68a, 70a.

FIG. 2b shows a detail view of the heating coil 10a and of the fixing device 14a in a cutaway drawing. The section comprises the winding 12a, the further winding 13a, the support element 28a and, by way of example, the first retaining element 20a and the fifth retaining element 64a. The following description can, however, be transferred analogously to the other retaining elements 22a, 24a, 26a, 66a, 68a, 70a and/or the other support element 30a.

The first retaining element 20a and the fifth retaining element 64a are embodied as a wire-like body. The first retaining element 20a and the fifth retaining element 64a encompass a respective winding 12a, 13a at least for the most part. The first retaining element 20a and the fifth retaining element 64a here penetrate the support element 28a, so that an end area 82a, 84a of the first retaining element 20a and an end area 86a, 88a of the fifth retaining element 64a engage behind the support element 28a and hereby in particular fix the windings 12a, 13a onto the support element 28a.

FIG. 2c shows the detail view of the heating coil 10a and the fixing device 14a viewed from above. The cooking device comprises a positioning unit 34a. The positioning unit 34a is provided for positioning of the retaining unit 18a and the support unit 16a relative to the heating coil 10a. To this end, the positioning unit 34a comprises a number of positioning elements 35a, wherein, for the sake of clarity, in FIG. 2c in particular only one of the positioning elements is provided with a reference character. The number of positioning elements 35a is here matched to the number of retaining elements 20a, 22a, 24a, 26a, 64a, 66a, 68a, 70a. In the present case, exactly one positioning element 35a is assigned to each of the retaining elements 20a, 22a, 24a, 26a, 64a, 66a, 68a, 70a. The positioning elements 35a are here identical to each other.

The positioning element 35a is embodied in one piece with the winding 12a of the heating coil 10a. The positioning element 35a is embodied as a recess in the winding 12a of the heating coil 10a. The positioning element 35a is embodied bilaterally in the winding 12a. The positioning element 35a is embodied corresponding to the first retaining element 20a. Alternatively, it is also conceivable to dispense totally or at least partially with a positioning unit. It is further conceivable to embody a positioning element on one side only in a winding.

FIG. 2d shows a detail view of the heating coil 10a and of the fixing device 14a, as described in FIGS. 2b and 2c, wherein a longitudinal section in the direction of the winding 12a is represented. This embodiment differs from the previous embodiments in that the winding 12a has positioning elements 35a in the form of recesses in the center of the winding 12a, and the first retaining element 20a connects the winding 12a to the support element 28a by means of two positioning elements 35a, wherein the first retaining element 20a penetrates the support element 28a. Alternatively, it could have a single positioning element 35a and the first retaining element 20a could penetrate it through one side of the winding 12a, by means of which this fixes the winding 12a to the support element 28a.

FIG. 2e shows a detail view of the heating coil 10a and the fixing device 14a, viewed from above FIG. 2d.

FIGS. 3a to 6 show further exemplary embodiments of the invention. The subsequent descriptions and the drawings confine themselves essentially to the differences between the exemplary embodiments, wherein with regard to identically designated components, in particular with regard to components with the same reference character, reference can also in principle be made to drawings and/or the description of the other exemplary embodiments, in particular from FIGS. 1 to 2c. To distinguish the exemplary embodiments, the letter ‘a’ is appended to the reference characters of the exemplary embodiment in FIGS. 1 to 2c. In the exemplary embodiments from FIGS. 3a to 6, the letter ‘a’ is replaced by the letters ‘b’ to ‘e’.

FIGS. 3a and 3b show a further exemplary embodiment of the invention. The letter ‘b’ is appended to the reference characters of this exemplary embodiment. The further exemplary embodiment from FIGS. 3a and 3b differs from the previous exemplary embodiment at least essentially in an embodiment of a retaining unit 18b of a fixing device 14b.

In this case a retaining element 20b, 24b, 26b of the retaining unit 18b is embodied in one piece with a heating coil 10b, in particular a winding 12b, 13b of the heating coil 10b. In the present case, at least one retaining element 20b, 24b, 26b is assigned to each winding 12b, 13b. Exactly one retaining element 20b is here assigned to inner windings of the heating coil 10b, while two retaining elements 24b, 26b are assigned to an outermost winding 13b of the heating coil 10b. The retaining elements 20b, 24b, 26b have an arrow-shaped contour. The retaining elements 20b, 24b, 26b are embodied as retaining hooks. The retaining elements 20b, 24b, 26b are arranged in corner areas of the heating coil 10b and extend in the direction of a coil center point. Alternatively, a retaining element can have a different form, for example a tip.

Furthermore, in the present case in particular a support unit 16b comprises at least one support element 28b of the support unit 16b, at least one retaining recess 32b. In the present case, the support unit 16b comprises a number of retaining recesses 32b, wherein for the sake of clarity in FIG. 3b in particular only one of the retaining recesses 32b is provided with reference characters. The number of retaining recesses 32b is here matched to the number of retaining elements 20b, 24b, 26b. In the present case exactly one retaining recess 32b is assigned to each of the retaining elements 20b, 24b, 26b. The retaining recesses 32b are in each case embodied corresponding to the retaining elements 20b, 24b, 26b. The retaining recesses 32b are here identical to each other. The retaining recesses 32b are provided to accommodate the retaining unit 18b, in particular the retaining elements 20b, 24b, 26b.

FIG. 4 shows a further exemplary embodiment of the invention. The letter ‘c’ is appended to the reference characters of the exemplary embodiment from FIG. 4. The further exemplary embodiment from FIG. 4 differs from the previous exemplary embodiment at least essentially in an embodiment of a retaining unit 18c of a fixing device 14c.

In this case, two retaining elements 20c, 22c, 24c, 26c are assigned to each winding 12c, 13c of a heating coil 10c. The retaining unit 18c with the retaining elements 20c, 22c is here arranged centrally in a straight coil section 74c of the winding 12c. In addition, a retaining recess 32c of a support unit 16c is assigned to each of the retaining elements 20c, 22c, 24c, 26c.

FIGS. 5a and 5b show a further exemplary embodiment of the invention. The letter ‘d’ is appended to the reference characters of the exemplary embodiment from FIGS. 5a and 5b. The further exemplary embodiment from FIGS. 5a and 5b differs from the previous exemplary embodiments at least essentially in an embodiment of a retaining unit 18d of a fixing device 14d.

FIG. 5a shows a heating coil 10d and the fixing device 14d viewed from above. In this embodiment, at least twelve retaining parts of the retaining unit 18d are assigned to a winding 12d. At least twelve retaining elements of the retaining unit 18d are assigned to each winding 12d of the heating coil 10d. In this exemplary embodiment, a support element 28d is arranged along a longitudinal extension direction 60d of a support unit 16d centrally between straight coil sections 74d. In the present case, the support element 28d is arranged perpendicular to a further support element 30d.

FIG. 5b shows a detail view of the fixing device 14d. In this case, retaining elements of the retaining unit 18d are embodied in multipart form and in the present case comprise for example three retaining parts 90d, 91d, 92d. Two retaining parts 90d, 91d are in each case embodied as bolts with a circular cross-section. A third retaining part 92d is embodied as a retaining clip.

A support unit 16d is here arranged between heating coil 10d and the third retaining part 92d, while the first and the second retaining part 90d, 91d in each case penetrate a retaining recess 32d, 33d, in order to realize a form-fitted and force-fitted connection. The form-fitted and force-fitted connection is embodied by means of a spot-welding method. Alternatively, or additionally, stapling, riveting and/or compression methods can also be employed.

FIG. 6 shows a further exemplary embodiment of the invention. The letter ‘e’ is appended to the reference characters of the exemplary embodiment from FIG. 6. The further exemplary embodiment from FIG. 6 differs from the previous exemplary embodiment at least essentially in an arrangement of a support unit 16e of a fixing device 14e and/or the number of support elements 28e, 29e, 30e, 31e of the support unit 16e.

A retaining unit 18e corresponds at least essentially to a retaining unit 18d of the previous exemplary embodiment. In this exemplary embodiment, however, the support unit 16d comprises four support elements 28e, 29e, 30e, 31e. The support elements 28e, 29e, 30e, 31e are oriented perpendicularly to each other. The support elements 28e, 29e, 30e, 31e here extend radially in the direction of a coil center point 48e, starting from a corner area of a heating coil 10e.

### REFERENCE CHARACTERS

10 Heating coil
12 Winding
13 Winding
14 Fixing device
16 Support unit
18 Retaining unit
20 Retaining element
22 Retaining element
24 Retaining element
26 Retaining element
28 Support element
29 Support element
30 Support element
31 Support element
32 Retaining recess
33 Retaining recess
34 Positioning unit
35 Positioning element
36 Muffle
38 Muffle wall
40 Cooking appliance
42 Cooking compartment
46 Cooking appliance housing
48 Coil center point
50 Coil plane
52 Coil axis
56 Connection element
60 Longitudinal extension direction
62 Longitudinal extension direction
64 Retaining element
66 Retaining element
68 Retaining element
70 Retaining element
74 Coil section
76 Coil section
78 Coil section
80 Coil section
82 End area
84 End area
86 End area
88 End area
90 Retaining part
91 Retaining part
92 Retaining part

1-13. (canceled)

14. A cooking device, comprising:
a heating coil including at least two windings; and
a fixing device configured to fix the heating coil at least partially mechanically in an assembled state, said fixing device including a support unit and a retaining unit, which in the assembled state fixes each of the at least two windings separately on the support unit.

15. The cooking device of claim 14, wherein the retaining unit is made at least partially of a material with a thermal expansion coefficient which is at least essentially identical to a thermal expansion coefficient of the heating coil.

16. The cooking device of claim 14, wherein the retaining unit includes a multiplicity of retaining elements, wherein at least two of the retaining elements are assigned to at least one of the at least two windings.

17. The cooking device of claim 14, wherein the retaining unit is embodied at least partially in one piece with the heating coil.

18. The cooking device of claim 14, wherein the retaining unit includes a retaining element, which is embodied as a retaining clasp, a retaining hook, a retaining clip and/or a retaining bolt.

19. The cooking device of claim 14, wherein the support unit is embodied at least partially to be electrically insulating.

20. The cooking device of claim 14, wherein the support unit includes a multiplicity of at least essentially strip-like support elements.

21. The cooking device of claim 20, wherein in an assembled state the support elements are arranged at least essentially perpendicular to each other.

22. The cooking device of claim 14, wherein the support unit has at least one retaining recess to accommodate the retaining unit.

23. The cooking device of claim 14, further comprising a positioning unit configured to position at least one of the retaining unit and the support unit relative to the heating coil.

24. The cooking device of claim 14, wherein the retaining unit includes an electrically conductive retaining element, said support unit being arranged between the retaining element of the retaining unit and the heating coil, said retaining element configured to penetrate a retaining recess of the support unit for establishing a connection to the heating coil.

25. A cooking appliance, comprising a cooking device, said cooking device comprising a heating coil including at least two windings, and a fixing device configured to fix the heating coil at least partially mechanically in an assembled state, said fixing device including a support unit and a retaining unit, which in the assembled state fixes each of the at least two windings separately on the support unit.

26. The cooking appliance of claim 25, wherein the retaining unit is made at least partially of a material with a thermal expansion coefficient which is at least essentially identical to a thermal expansion coefficient of the heating coil.

27. The cooking appliance of claim 25, wherein the retaining unit includes a multiplicity of retaining elements, wherein at least two of the retaining elements are assigned to at least one of the at least two windings.

28. The cooking appliance of claim 25, wherein the retaining unit is embodied at least partially in one piece with the heating coil.

29. The cooking appliance of claim 25, wherein the retaining unit includes a retaining element, which is embodied as a retaining clasp, a retaining hook, a retaining clip and/or a retaining bolt.

30. The cooking appliance of claim 25, wherein the support unit is embodied at least partially to be electrically insulating.

31. The cooking appliance of claim 25, wherein the support unit includes a multiplicity of at least essentially strip-like support elements.

32. The cooking appliance of claim 31, wherein in an assembled state the support elements are arranged at least essentially perpendicular to each other.

33. The cooking appliance of claim 25, wherein the support unit has at least one retaining recess to accommodate the retaining unit.

34. The cooking appliance of claim 25, wherein the cooking device includes a positioning unit configured to position at least one of the retaining unit and the support unit relative to the heating coil.

35. The cooking appliance of claim 25, wherein the retaining unit includes an electrically conductive retaining element, said support unit being arranged between the retaining element of the retaining unit and the heating coil, said retaining element configured to penetrate a retaining recess of the support unit for establishing a connection to the heating coil.

36. A method for assembly of a cooking device, comprising at least partially mechanically fixing with a fixing device a heating coil of the cooking device such that each of at least two windings of the heating coil is fixed separately to a support unit of the fixing device by a retaining unit of the fixing device.
